(19) United States
(12) Patent Application Publication
(10) Pub. No.: US 2007/0273721 A1
(43) Pub. Date: Nov. 29, 2007

(54) Method for obtaining an image, and an ink jet printer for performing the method

(75) Inventor: Johannes M. M. Simons, Venlo (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/802,506

(22) Filed: May 23, 2007

(30) Foreign Application Priority Data
May 24, 2006 (EP) 06114501.7

(51) Int. Cl. B41J 29/38

(52) U.S. Cl. 347/14

(57) ABSTRACT

A method and apparatus for obtaining an image consisting of multiple ink droplets placed at a plurality of locations on a receiving substrate, using an inkjet printer containing an ink chamber having an ink droplet ejection site, and a transducer operatively associated with said chamber, wherein each of the ink droplets, determining a desired accuracy of placement of the droplet on the substrate, the accuracy corresponding to the speed at which the droplet is jetted from the chamber, generating an electrical pulse corresponding to the said speed of the droplet, and applying an electrical pulse to the transducer in order to provide a pressure wave in the ink chamber whereby the ink droplet is ejected from the chamber essentially at said speed.

### CROSS-REFERENCE TO RELATED APPLICATION

This application claims priority from European Patent Application No. 06114501.7 filed on May 24, 2006, the entire contents of which is hereby incorporated by reference in its entirety.

### BACKGROUND OF THE INVENTION

1. Field of the Invention

The present invention pertains to a method for obtaining an image consisting of multiple ink droplets placed at a plurality of locations on a receiving substrate, using an inkjet printer comprising an ink chamber having an ink droplet ejection site, and a transducer associated with the said chamber. The present invention also pertains to an ink jet printer for performing the present method.

2. Description of the Background Art

In an inkjet printer of the above introduced type, an electrical pulse can be applied to the transducer (the pulse being any electrical signal that can be used to energize the transducer), whereupon the transducer (e.g., of an electro-mechanical or electro-thermal type) creates a pressure wave in the ink chamber. This pressure wave will force a small volume of ink to be expelled from the ink ejection site. Depending on the size and shape of the pulse, all kinds of pressure waves can be induced. In this way, the size and speed of the ink jet droplets can be controlled, albeit that the physical constraints of the print head determine the maximum and minimum values for size and speed.

As is generally known in the art of ink jet printing, the print quality depends on the speed at which droplets are jetted from the ink jet print head. Droplets with a high speed namely have a relatively short flying time before they impact the receiving substrate. The accuracy of placement of such droplets is therefore intrinsically higher than for droplets with a low speed. It therefore seems advantageous to design an ink jet print head which ejects all droplets at the highest possible speed, in order to attain maximum ink droplet placement accuracy and thus maximum print quality. However, the applicant has recognised that jetting droplets at an increased speed means that the droplet formation process itself gives raise to an increased chance of droplet ejection failure. In particular, when ink droplets are jetted at nearly maximum speed, the chance of ink ejection failure increases significantly. Ink ejection failure on its turn gives rise to print artefacts and thus leads to a deterioration of the print quality. In order to obtain maximum overall print quality, it seems that one should thus choose for a moderate ink droplet speed.

### SUMMARY OF THE INVENTION

However, the applicant has recognized that a significantly better print quality can be obtained by applying an improved print method. This method comprises for each of the ink droplets to be jetted, determining a desired accuracy of placement of the droplet on the substrate, the accuracy corresponding to a speed at which the droplet is jetted from the chamber, generating an electrical pulse corresponding to the said speed of the droplet, and applying the electrical pulse to the transducer in order to provide a pressure wave in the ink chamber, such that the ink droplet is ejected from the chamber essentially at the said speed.

With this method, it is firstly determined what the accuracy of ink droplet placement should be for the ink droplets that are due to be jetted according to the image to be obtained. Applicant has recognized that the print quality of certain image parts can be very high, despite the fact that for the droplets forming these image parts the accuracy of placement is low. For example, in areas where the ink coverage is 100%, the accuracy of droplet placement can be very low (typically a deviation of tens of micrometers up to even 100 μm can be accepted) without inducing visible print artefacts. On the other hand, when droplets are being used to represent details of which the actual position in the image is of extreme importance (for example, engineering details in drawings, or tracks that represent connections in nano-imprint lithography techniques etc.) the accuracy of ink droplet placement should be very high (typically within a few percent of droplet size). In this way, for all droplets that are intended to make part of the image a desired accuracy of droplet placement will be determined. The accuracy on its turn corresponds to a speed at which the droplet should be jetted from the ink ejection site. High accuracy corresponds to a high droplet speed, whereas a low accuracy corresponds to a low droplet speed. This way, it is clear for all droplets at which speed they should be jetted. Attaining the right speed, means providing a pulse to the transducer that is designed to provide that speed. It is generally known in the art that by tuning and adapting pulses different droplet speeds can be achieved. Thus, for each droplet a dedicated pulse is generated, which pulse, when applied to the transducer corresponding to that droplet, should provide a pressure wave in the ink chamber such that the ink droplet is ejected from the chamber essentially at the speed to obtain the desired accuracy of droplet placement.

With this method, the droplets for which placement accuracy is less important with respect to print quality, are jetted at low to moderate ink ejection speeds (i.e., at speeds significantly lower than the maximum attainable ejection speed). This has the advantage that the chances of ink ejection failure are practically zero, without introducing disturbing print artefacts arising from droplet misplacement. On the other hand, those droplets which actually need a very high accuracy of droplet placement in order to obtain a high print quality, are jetted at correspondingly high droplets speeds. Indeed, when ejecting these droplets the chances of ink ejection failure are relatively high, but since these high speeds are only induced when really needed (and thus in general, for only a minor part of the ink droplets), the overall chances of ink ejection failure are typically still very low. In short, in the method according to the present invention, high droplet speeds are only desired when high droplet placement accuracy is needed for obtaining a high print quality. For the other droplets lower speeds will be used. This means that the risk of overall ink ejection failure is significantly lower with respect to the case wherein all droplets are jetted at high droplet speeds. This contributes to a better overall print quality, as compared to the case wherein one single (moderate) speed is chosen for all ink droplets.

It will be clear to the skilled practitioner that in order to apply the present invention it is not needed to determine an absolute value for the accuracy of droplet placement (such as, for example, setting a maximum droplet deviation at X micrometers). It is also possible for example to create three categories of accuracy (High—Moderate—Low), and assess for each droplet the category to which it belongs. For each desired accuracy, it being either an absolute value or a relative value, the skilled man can determine what a corresponding droplet speed should be in order to arrive at this accuracy. given all the system properties. This could for example be done experimentally by varying the speed continuously and registering the accuracy which is attained. Once the relationship is determined, it is clear how the corresponding droplet speed can be provided.

It is also noted that the desired accuracy need not be determined for each droplet individually. In many cases it will be clear that certain groups of droplets should have the same desired accuracy. If so, the desired accuracy can be determined for this complete group of nozzles as a whole. Next to this, the invention can also be applied for images that form part of a larger image. For example, for some applications it is adequate that the invention is only applied for a sub-image of a complete image to be formed. For 3D modelling, for example, it is typically sufficient to apply the present invention only for the sub-images that form the outermost parts of the 3D image. The inner parts are not visible, so image quality is often hardly important for those parts. In full-color printing, one could apply the present invention only for the most prominent color sub-images, for example the Black and Magenta images. Print quality is less of an issue for the Yellow sub-image. For whatever reason one could also apply the present invention to some parts of an image, for example, the center or lower parts of an image, those parts then corresponding to an “image” as defined in the appended claims. In short, the invention can be applied for any image, no matter how this image is defined, that is, part of a larger image.

In an embodiment wherein the chamber is substantially closed, the ejection site being a nozzle of said chamber, the transducer is an electro-mechanical transducer which is operatively connected to the ink chamber, which transducer deforms on application of said pulse and thereupon induces the pressure wave. In this embodiment, use is made of a transducer, e.g., a piezoelectric or electrostatic transducer, which upon actuation, induces a sudden volume-change of the chamber. Typically an electrical pulse is applied such that the chamber volume firstly increases which leads to “over-filling” of the chamber, whereafter the chamber is brought back to its equilibrium dimensions. The ink being, in principal, incompressible, the latter change will lead to pressure waves that, if strong enough, ultimately lead to ejection of an ink droplet. Applicant has recognized that the application of an electromechanical transducer is very advantageous for the present invention, since with such transducer droplet speed can be very precisely controlled. By tuning the electrical pulse, a very broad range of droplet speeds can be attained.

In a further embodiment wherein the pressure wave in its turn induces a deformation of the transducer such that the transducer generates a corresponding electrical signal, this latter signal is measured in order to establish the effect of the droplet ejection step in the ink chamber. In this embodiment a transducer is used which generates an electrical signal upon its deformation, e.g., a piezoelectric transducer. The pressure waves which are induced in the ink, on their turn will deform the electro-mechanical transducer. The transducer will then generate an electrical signal that corresponds to the pressure waves. By analysing the generated signal, clear information is provided about the circumstances in the chamber during the time the pressure waves run through the chamber. In other words, information can be gathered about the physical effect the droplet ejection step has in the chamber. It is noted that, in general, it is known (e.g., from U.S. Pat. No. 6,682,162; U.S. Pat. No. 6,926,388 and U.S. Pat. No. 6,910,751) that by analysing such a signal, information about the circumstances in an ink chamber can be gathered. However, it has heretofore not been known that this information can be advantageously used to tune the method according to the present invention. If, for example, it is established that the effect of the actuation was a droplet speed that diverted too much of the intended one, it is possible to alter the actuation for the next droplet ejection.

In another embodiment the accuracy for each droplet is determined according to the type of image information which is to be formed using the droplet. In this embodiment, use is made of the fact that in many applications, the accuracy of droplet placement needed to achieve an adequate print quality can be established in dependence on the type of image information. For example, it is generally known for text characters what kind of droplet misplacement is acceptable for certain applications. The same is true for full color photographs (where typically the droplet placement accuracy needed is somewhat lower than for text). For applications such as printing masks for nano imprint lithography or the fabrication of printed circuit boards directly, more stringent requirements will be in place. This all depends on the desired accuracy of the ultimate printed substrate.

The present invention also pertains to an ink jet printer of the type having an ink chamber with an ink droplet ejection site, a transducer associated with the ink chamber and a pulse generator for applying an electrical pulse to the transducer in order to provide a pressure wave in the ink chamber, wherein the printer contains a controller arrangement that is devised in order to make the printer perform a method according to the present invention as described here-above. Such a controller arrangement can be a single piece of hardware, such as an ASIC, but can also be devised as an arrangement distributed over several components or even separate hardware devices, optionally partly or substantially completely constituted in software. For the skilled man it will be clear that the actual constitution of the controller arrangement is not essential for enabling the application of the present invention.

### BRIEF DESCRIPTION OF THE DRAWINGS

The present invention will be outlined in greater detail with reference to the following drawings wherein,

FIG. 1 is a diagram showing an inkjet printer;

FIG. 2 is a diagram showing an ink chamber assembly and its associated transducer;

FIG. 3 shows a relationship between the electrical pulse and the pressure wave which is induced;

FIG. 4 shows a relationship between the accuracy of ink droplet placement and the ink droplet speed;

FIG. 5 shows a relationship between the reliability of an ink droplet ejection process and the ink droplet ejection speed;

FIG. 6 shows an example of a substrate to be printed with various types of image information; and

FIG. 7 is a block diagram showing a circuit that is suitable for measuring the effect of the droplet ejection in the ink chamber by the application of the transducer as a sensor.

### DETAILED DESCRIPTION OF THE INVENTION

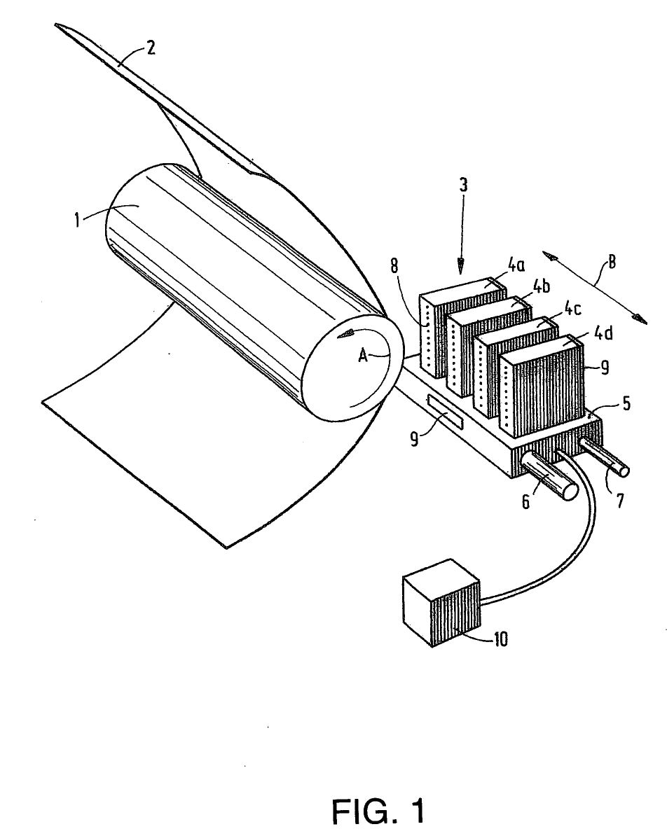

FIG. 1 is a diagram showing an inkjet printer. According to this embodiment, the printer comprises a roller 1 used to support a receiving medium 2 (receiving substrate), such as a sheet of paper or a transparency which is moved along the carriage 3. The carriage includes a carrier 5 to which four printheads 4a, 4b, 4c and 4d have been fitted. Each printhead contains its own color, in this case cyan (C), magenta (M), yellow (Y) and black (K), respectively. The printheads are heated using heating elements 9, which have been fitted to the rear of each printhead 4 and to the carrier 5. The temperature of the printheads is maintained at a desired level by the application of a central controller 10. This arrangement also includes the necessary components in order to enable the printer to perform the method according to the present invention.

The roller 1 may rotate around its own axis as indicated by arrow A. In this manner, the receiving medium may be moved in the sub-scanning direction (often referred to as the X direction) relative to the carrier 5, and therefore also relative to the printheads 4. The carriage 3 may be moved in reciprocation using suitable drive mechanisms (not shown) in a direction indicated by double arrow B, parallel to roller 1. To this end, the carrier 5 is moved across the guide rods 6 and 7. This direction is often referred to as the main scanning direction or Y direction. In this manner, the receiving medium may be fully scanned by the printheads 4.

According to the embodiment as shown in this figure, each printhead 4 comprises a number of internal ink chambers (not shown), each with its own ejection site (in this case a nozzle) 8. The nozzles in this embodiment form one row per printhead perpendicular to the axis of roller 1 (i.e., the row extends in the sub-scanning direction). In a practical embodiment of an inkjet printer, the number of ink chambers per printhead will be many times greater and the nozzles will be arranged over two or more rows. Each ink chamber is provided with a piezo-electric transducer (not shown) which is adapted to generate a pressure wave in the ink chamber so that an ink drop is ejected from the nozzle of the associated chamber in the direction of the receiving medium. This droplet then travels through the air in the direction of the receiving medium 2. The exact location of placement of the droplet on the receiving medium depends, among other things, on the speed of the droplet. Since the desired speed is known beforehand, it can be calculated when each transducers should be actuated in order for a droplet to arrive at the intended location. The transducers are actuated, image-wise, via an associated electrical drive circuit (not shown) by the application of the central control unit 10. In this manner, an image built up of ink drops may be formed on receiving medium 2.

If a receiving medium is printed using such a printer where ink drops are ejected from ink chambers, the receiving medium, or a part thereof, is imaginarily split into fixed locations that form a regular field of pixel rows and pixel columns. According to one embodiment, the pixel rows are perpendicular to the pixel columns. The individual locations thus produced may each be provided with one or more ink drops. The number of locations per unit of length in directions parallel to the pixel rows and pixel columns is called the resolution of the printed image, for example indicated as 400×600 d.p.i. (“dots per inch”). By actuating a row of printhead nozzles of the inkjet printer, image-wise, when it is moved relative to the receiving medium as the carrier 5 moves, an image, or part thereof, built up of ink drops is formed on the receiving medium, or at least in a strip as wide as the length of the nozzle row.

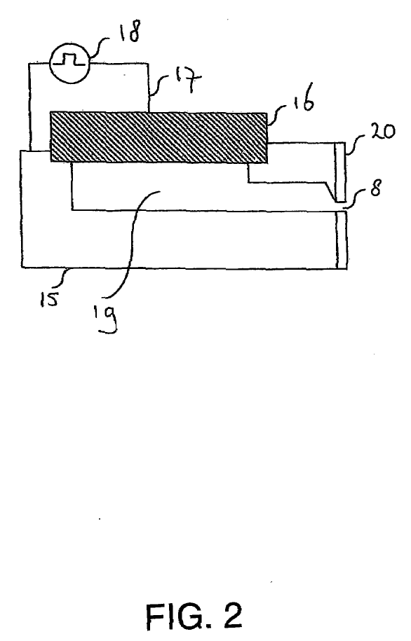

FIG. 2 shows an ink chamber 19 and a piezo-electric transducer 16. Ink chamber 19 is formed by a groove in base plate 15 and is limited at the top mainly by piezo-electric transducer 16. Ink chamber 19 converges into an exit opening 8 at the end thereof, this opening being partly formed by a nozzle plate 20 in which a recess has been made at the level of the chamber. When a pulse is applied across transducer 16 by the pulse generator 18 via the actuation circuit 17, the transducer bends in the direction of the chamber. This produces a sudden pressure rise in the chamber which, in turn, generates a pressure wave in the chamber. According to an alternative embodiment, the transducer first bends away from the chamber, thus drawing in ink via an inlet opening (not shown), after which the transducer is moved back into its initial position. This also produces a pressure wave in the chamber. If the pressure wave is strong enough, an ink drop is ejected from exit opening 8. After the expiration of the ink drop ejection process, the pressure wave, or a part thereof, is still present in the chamber, after which the pressure wave will fully damp over time. This pressure wave, in turn, results in a deformation of transducer 16, which then generates an electric signal. This signal depends on all the parameters that influence the generation and the damping of the pressure wave. In this manner, as known from European patent application EP 1 013 453, it is possible, by measuring this signal, to obtain information on these parameters, such as the presence of air bubbles or other undesirable obstructions in the chamber. This information may then, in turn, be used to check and control the printing process.

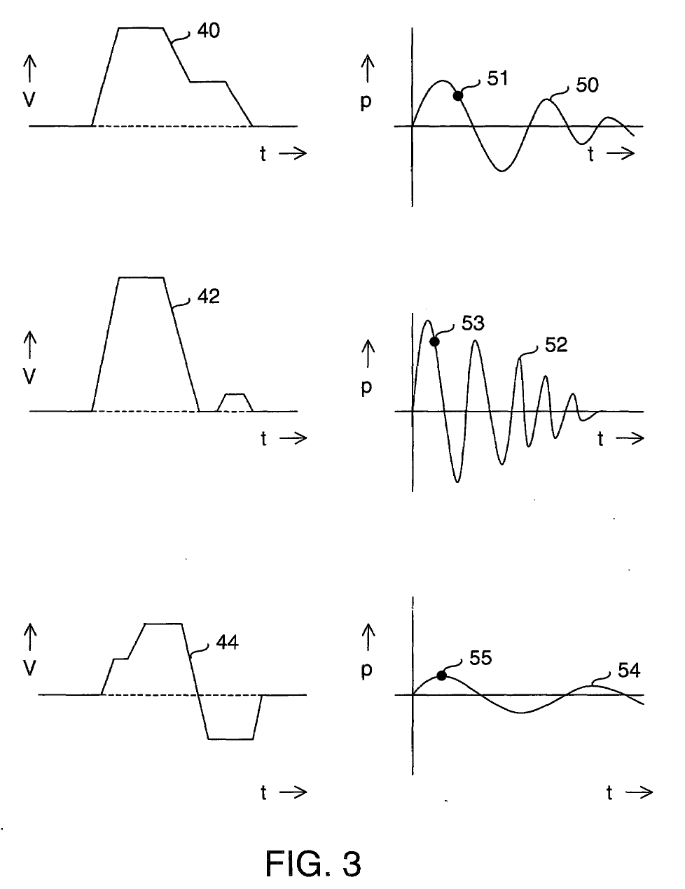

In FIG. 3 a relationship between the electrical pulse and pressure wave induced is shown. For this, three examples of electrical pulses and corresponding pressure waves in the ink chamber are schematically provided in the figure. Firstly electrical pulse 40 is shown, which pulse is schematically represented as a varying voltage V during a time t. When this pulse is applied to the transducer 16 as depicted in FIG. 2, a pressure wave 50 is induced in the ink in the corresponding ink chamber. This pressure wave is schematically represented as a varying pressure P during a time t. Dot 51 indicates the moment when an ink droplet is actually ejected from the nozzle of the ink chamber. This droplet has a speed of 6 meters per second, which speed corresponds to the electrical pulse 40 for this ink chamber.

In the second example the electrical pulse 42 is shown, which pulse is also schematically represented as a varying voltage V during a time t. When this pulse is applied to the transducer 16 as depicted in FIG. 2, a pressure wave 52 is induced in the ink in the corresponding ink chamber. This pressure wave is schematically represented as a varying pressure P during a time t. It can be seen that this pressure wave differs substantially from wave 50 in that the amplitude and frequency are higher. Dot 53 indicates the moment when an ink droplet is actually ejected from the nozzle of the ink chamber. This droplet has a speed of 8 m/sec, corresponding to the electrical pulse 42 for this ink chamber.

A third example is given wherein electrical pulse 44 is shown, which pulse is also schematically represented as a varying voltage V during a time t. When this pulse is applied to the transducer 16 as depicted in FIG. 2, a pressure wave 54 is induced in the ink in the corresponding ink chamber. This pressure wave is schematically represented as a varying pressure P during a time t. This wave differs substantially from waves 50 and 52. Dot 51 indicates the moment when an ink droplet is actually ejected from the nozzle of the ink chamber. This droplet has a speed that corresponds to the electrical pulse 44. In this case, the speed is 5 m/sec.

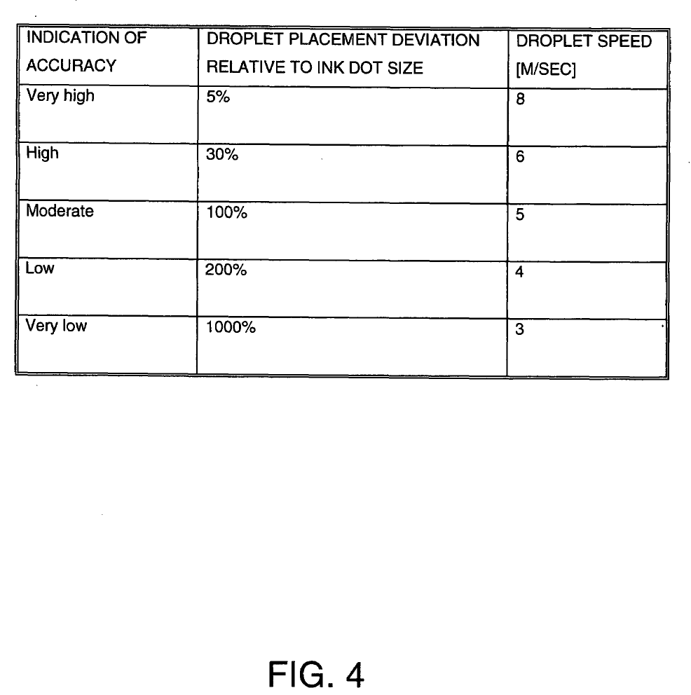

FIG. 4 shows the relationship between the accuracy of ink droplet placement and the ink droplet speed. In the table, the first column shows a relative indication of the ink droplet placement accuracy, going from “Very high,” through “High,”“Moderate” and “low” to “very Low.” The dot placement accuracy corresponding to these indications is depicted in the second column by giving the droplet placement deviation as a percentage relative to the ink dot size after hitting the receiving substrate. Typically an ink dot has a size of 10 μm in diameter. A very high accuracy in this particular example thus corresponds to an ink droplet placement deviation of 5% of 10 μm which equals 0.5 μm. A very low accuracy in this example corresponds to an ink droplet placement deviation of 1000% of 10 μm which equals 100 μm.

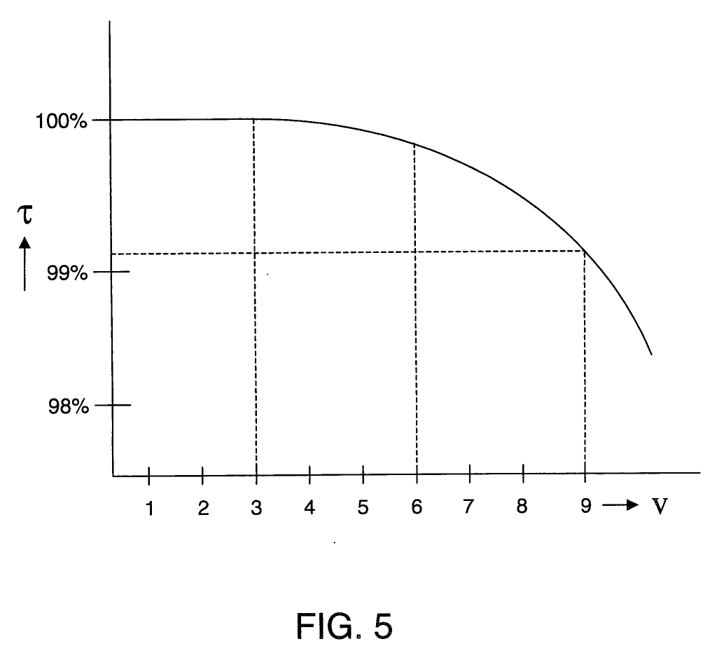

FIG. 5 shows a relationship between the reliability of an ink droplet ejection process and the ink droplet ejection speed. Vertically, the reliability τ for ink droplet ejection process is given, i.e., as an average value for all the ink chambers of an ink jet print head. A reliability of 100% means that ink droplet forming process will always be successful. A reliability of, e.g., 98% means that, on average, two out of one hundred intended droplets will not be adequately formed (i.e., will not be formed in a way that they will hit the receiving substrate).

Horizontally the ink droplet ejection speed is given. For this particular print head it can be seen that with speeds up to 3 m/sec, the reliability is virtually 100%. After that the reliability starts to decrease noticeably, but up to 6 m/sec this will in general not lead to any disturbing print artefacts for regular ink jet prints. At a speed of 9 m/sec, the reliability has decreased to approximately 99%. This value in this example is regarded as a limit for good ink jet printing. Above that speed, the reliability is so low that print artefacts are becoming disturbingly visible. It may be clear for the skilled person that the actual relationship between the reliability and the ink droplet speed depends strongly on the type of ink jet head. This relationship has to be established for each inkjet head. In practice this can be done by varying the ink droplet speed and measuring the number of actual droplet ejections relative to the intended number of ink droplet ejections. Also, which reliability is still acceptable also largely depends on the application. For example, for text printing, less stringent demands will generally apply as compared to CAD drawings.

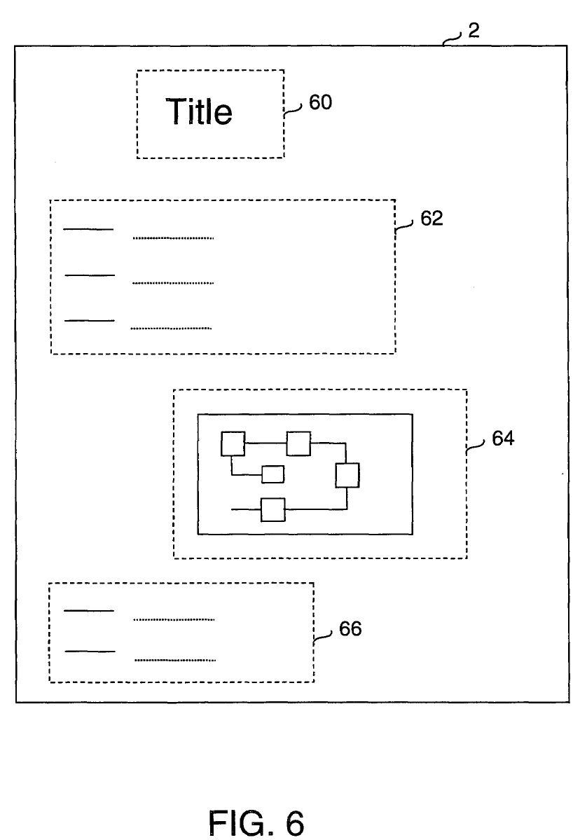

FIG. 6 shows an example of a substrate to be printed with an ink jet printer according to the present invention. The substrate is divided into parts intended for various types of image information. Substrate 2 is a transparent plastic medium that is being used as a mask in the prochamberion of printed circuit boards. Sub-part 60 is intended for an image that shows the title of the mask. The print quality needed for this type of image information is “Very low.” Sub-part 62 is intended for an image that reflects a technical specification of the actual mask. The print quality needed for this image is “Moderate” with respect to figures in the specification and “Low” with respect to text in the specification. Sub-part 64 is intended to receive the actual print mask. The print quality needed for this part of the substrate is “Very High.” Sub-part 66 is intended for an image that shows the date of prochamberion of the mask and other tracking data. The print quality needed for this type of image information is “low.”

When printing this substrate with the ink jet printer according to FIG. 1, using the method according to the present invention, only sub-part 64 will be printed with very high droplet speeds. The print quality of this part of the complete image, i.e., the print quality with respect to ink droplet placement, will be very high. The chances of ink droplet ejection failure are somewhat higher than for the other parts of the receiving substrate, but still low enough to guarantee an adequate image. The other parts are printed with lower ink droplet ejection speeds. Note that in part 62 two different droplet speeds will be used. A moderate speed with respect to figures to be printed and a low speed with respect to text to be printed.

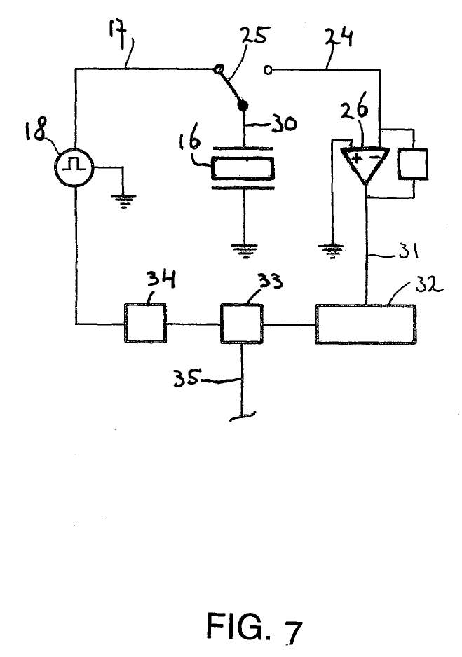

FIG. 7 is a block diagram showing the piezo-electric transducer 16, the actuation circuit (items 17, 25, 30, 16 and 18), the measuring circuit (items 16, 30, 25, 24, and 26) and control unit 33 according to one embodiment. The actuation circuit, comprising a pulse generator 18, and the measuring circuit, comprising an amplifier 26, are connected to transducer 16 via a common line 30. The circuits are opened and closed by two-way switch 25 which can be devised as a hardware switch or as any other arrangement that electrically mimics the same effect. Once a pulse has been applied across transducer 16 by pulse generator 18, item 16 is, in turn, deformed by the resulting pressure wave in the ink chamber. This deformation is converted into an electric signal by transducer 16. After the expiration of the actual actuation, two-way switch 25 is converted so that the actuation circuit is opened and the measuring circuit is closed. The electric signal generated by the transducer is received by amplifier 26 via line 24. According to this embodiment, the resulting voltage is fed via line 31 to A/D converter 32, which offers the signal to control unit 33. This is where the measured signal is analysed. In this way, clear information can be provided about the circumstances in the chamber during the time the pressure waves run through the chamber. In other words, information can be gathered about the physical effect the droplet ejection step had in the chamber. If necessary, a signal is sent to pulse generator 18 via D/A converter 34 so that a subsequent actuation pulse is modified to the current state of the chamber. Control unit 33 is connected to the central control unit of the printer (not shown in this figure) via line 35, allowing information to be exchanged with the rest of the printer and/or the outside world.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim.

1. A method for obtaining an image consisting of multiple ink droplets placed at a plurality of locations on a receiving substrate, using an inkjet printer comprising an ink chamber having an ink droplet ejection site, and a transducer associated with said chamber, said method comprising, for each of the ink droplets,
determining a desired accuracy of placement of the droplet on the substrate, the accuracy corresponding to a speed at which the droplet is jetted from the chamber,
generating an electrical pulse corresponding to the speed of said droplet, and
applying the electrical pulse to the transducer in order to provide a pressure wave in the ink chamber, such that the ink droplet is ejected from the chamber essentially at said speed.

2. The method according to claim 1, wherein the chamber is substantially closed and the ejection site is a nozzle of said chamber, and wherein the transducer is an electro-mechanical transducer which is operatively connected to the ink chamber, said transducer deforming on an application of said pulse and inducing the pressure wave.

3. The method according to claim 2, wherein the pressure wave, in turn, induces a deformation of the transducer such that the transducer generates a corresponding electrical signal, and wherein the signal is measured in order to establish the effect of the droplet ejection step in the ink chamber.

4. The method according to claim 1 wherein the accuracy for each droplet is determined according to the type of image information which is to be formed using the droplet.

5. An ink jet printer comprising:
an ink chamber having an ink droplet ejection site,
a transducer operatively associated with the ink chamber,
a pulse generator for applying an electrical pulse to the transducer in order to provide a pressure wave in the ink chamber, wherein the printer comprises a controller that is devised to enable the printer to perform the method of claim 1.
